(19) United States
(12) Patent Application Publication
(10) Pub. No.: US 2025/0251581 A1
(43) Pub. Date: Aug. 7, 2025

(54) MICROLENS ARRAY FOR AN IMAGE PROJECTOR

(71) Applicant: FEV Group GmbH, Aachen (DE)

(72) Inventors: Steffen JENTSCH, Osnabrück (DE); Martin MUELLER, Osnabrück (DE); Alf RIEDEL, Osnabrück (DE); Felix VON LAFFERT, Osnabrück (DE); Christian VOGL, Thalgau (AT)

(73) Assignee: FEV Group GmbH, Aachen (DE)

(21) Appl. No.: 19/184,372

(22) Filed: Apr. 21, 2025

Related U.S. Application Data
(63) Continuation of application No. PCT/DE2023/100771, filed on Oct. 16, 2023.

(30) Foreign Application Priority Data
Oct. 21, 2022 (DE) 102022127905.7

(51) Int. Cl. G02B 13/16; G02B 3/00

(52) U.S. Cl. CPC G02B 13/16; G02B 3/0037

(57) ABSTRACT

A microlens array for an image projector includes a carrier and a matrix-shaped arrangement with a plurality of lenses which are arranged on the carrier. A microlens array arrangement is also provided, which includes a first microlens array at an illumination side and a second microlens array at a projection side. Each of the first microlens array and the second microlens array has a structure of said microlense array.

### CROSS-REFERENCE TO RELATED APPLICATIONS

This application is a continuation application of PCT/DE2023/100771, filed Oct. 16, 2023, which claims priority to DE 10 2022 127 905.7, filed Oct. 21, 2022. The disclosures of the above applications are incorporated herein by reference.

### FIELD

The present disclosure relates to a microlens array for an image projector, an image projector comprising a microlens array, a microlens array arrangement, and a method for fabricating a microlens array.

### BACKGROUND

The statements in this section merely provide background information related to the present disclosure and may not constitute prior art.

For smaller projectors, which are designed as stack along the optical axis, in the last few years image projectors comprising microlens arrays (MLA) are used, in particular in the automative sector. Said projectors typically comprise collimation optics, generating collimated light with a certain small residual divergence, an optical stack with an illumination lens array, a slide plane (made of a chromium layer) in which the image information is provided by apertures, a substrate as thick as the focal length (made of glass) and a projection lens array, which is often identical to the illumination lens array.

In addition, the image projector comprises electronics, a housing and a front lens. Thus, multi-channel optics of smaller dimensions is created, wherein each channel can project the entire image with a high depth of focus.

Publication DE 10 2009 024 894 A1 relates to a projection display comprising one light source as well as optical channels arranged evenly. The optical channels comprise a field lens, which is assigned one object structure each to be displayed as well as a projection lens. The distance between the projection lenses and the assigned object structures corresponds to the focal length of the projection lenses, while the distance between the object structures to be displayed and the assigned field lens is selected such that a Köhler illumination of the associated projection lens becomes possible, resulting in an overlapping of the individual projections in order to create the overall image.

### SUMMARY

This section provides a general summary of the disclosure and is not a comprehensive disclosure of its full scope or all of its features.

The microlens array for an image projector having a carrier and a matrix-shaped arrangement of a plurality of lenses arranged on a carrier is technically advantageous, in that it allows to fabricate microlens arrays in a manner that is more economical as compared to the expensive polymer-on-glass technology. In addition, a wider range of materials can be used, in particular for the carrier. Instead of polished glass wafers, all kinds of optical injection molding materials can be used.

In another preferred embodiment of the microlens array, the carrier and lenses are made from the same material, thus further simplifying the fabrication process of the microlens array.

In one preferred embodiment of the microlens array, the carrier has a thickness between 400 μm and 1200 μm, preferably between 500 μm and 700 μm. This allows the microlens array to be fabricated by means of injection molding or embossing.

In another preferred embodiment of the microlens array, the matrix-shaped arrangement having a plurality of lenses and the carriers are designed as single piece, thus making it possible for the microlens array to be fabricated by an injection molding process.

In another preferred embodiment of the microlens array, the microlens array is made of thermoplastic polymer, making it possible for the microlens array to be fabricated by injection molding as well.

In another preferred embodiment of the microlens array, the thermoplastic polymer includes polymethyl methacrylate (PMMA), cyclo-olefin-polymer (COP), polycarbonate (PC) or optical grade silicone. Those materials are particularly well suited for the fabrication of microlens arrays.

The microlens array arrangement according to the present disclosure, including a first microlens array at an illumination side and a second microlens array at a projection side can be inserted into a projector as a component. Between the first and the second microlens array, a slide plane can be arranged, having specially designed openings for the light to pass, thus simplifying the design further.

In a preferred embodiment of the microlens array arrangement, the first carrier has a thickness in the range of 400 μm to 1200 μm and the second carrier in the range of 2 mm to 5 mm.

In a preferred embodiment of the microlens array arrangement, the lenses of the first microlens array at the illumination side have a larger focal length than the lenses of the second microlens array at the projection side, thus generating a sharp projection and a high depth of focus.

In a preferred embodiment of the microlens array arrangement, the lenses of the first microlens array at the illumination side are characterized by a focal length inside the material which is equal to the sum of the thickness of the carrier of the first microlens array and the carrier of the second microlens array, thus improving the efficiency of the microlens array arrangement.

In one preferred embodiment of the microlens array arrangement, a slide plane is arranged between the first microlens array arrangement and the second microlens array arrangement.

The image projector according to the present disclosure including the microlens array arrangement offers the same technical advantages as the microlens array.

The method according to the present disclosure is used for the fabrication of a microlens array comprising the step of injection molding or embossing the microlens array. Said method offers the same technical advantages as the microlens array arrangement.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of an image projector comprising a microlens array according to the teachings of the present disclosure;

FIG. 2 is a schematic cross-sectional view of a microlens array according to the teachings of the present disclosure;

FIG. 3 is a schematic cross-sectional view of a microlens array arrangement according to the teachings of the present disclosure; and

FIG. 4 is a block diagram of a method for the fabrication of a microlens array arrangement according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

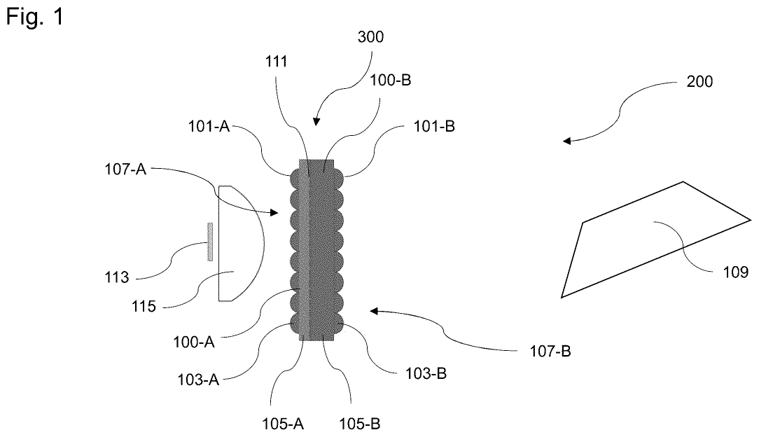

FIG. 1 shows a schematic representation of an image projector 200 having a microlens array arrangement 300 (MLA projector). The microlens array arrangement 300 comprises a first microlens array 100-A at an illumination side 107-A and a second microlens array 100-B at a projection side 107-B.

The image projector 200 projects a static, non-mutable image 109 onto a screen, such as a road or a wall. In this process, a preferably large luminous flux (lumen) is to be generated by using an image projector 200 which is as small as possible.

The image projector 200 comprises a light source 113 and a collimation lens 115 for generating parallel light rays. Nevertheless, the dimensions of the image projector 200, in particular along the axis of light propagation and the number of components should be kept as small as possible. This is in particular advantageous for lights used in the automotive sector where installation space is restricted. For this purpose, the image projector 200 is designed by using a multi-aperture approach, wherein miniaturized projectors (channels) having each separate lenses 103-A and 103-B are arranged parallel to each other, thus achieving a miniaturized design in regard to the thickness of the same.

In addition, it is possible to achieve a particularly high depth of focus by requiring only little space for the lenses 103-A and 103-B. This allows a sharp display of the image 109 on an inclined screen with different projection distances without the object—and lens planes being tilted (Scheimpflug principle).

In said embodiment, the same microlens arrays 100-A and 100-B having the same focal length are used for the lenses 103-A at the illumination side 107-A and for the lenses 103-B at the projection side 107-B. The focal length is selected such, that the respective focus lies on the opposite lens 103-A and 103-B (BL<->PL). As a result, in order to achieve a good illumination with the right collimation, preferably, there should be no space between the lenses 103-A at the illumination side 107-A and the slide plane 111.

The lenses 103-A, 103-B are fabricated by an injection molding process. The slide plane 111 is made of a chromium layer, in which the image information is provided by apertures.

The carrier 105-A is fabricated together with the lenses 103-A and arranged at the illumination side 101-A. Typically, the same is provided a thickness between 400 μm and 800 μm, in this embodiment 550 μm. The carrier 105-A or 105-B can be made of polymethyl methacrylate (PMMA) or cyclic olefin polymer (COP). This has the technical advantage of said materials being characterized by a low dispersion, which makes it possible to avoid color aberrations and colored edges in polychromatic white projections. Nevertheless, carrier 105-A and 105-B can also be made of polycarbonate or optical silicone. The carrier 105-A and 105-B can have a length between 5 mm and 50 mm and a width between 5 mm and 50 mm, preferably 10 mm by 10 mm. For instance, carrier 105-A typically is provided a thickness between 400 μm and 1200 μm and the carrier 105-B is provided a thickness between 2 mm and 5 mm.

The lenses 103-A and 103-B on the carrier 105-A and 105-B for instance, are provided a distance from the lens center to the lens center between 500 μm to 1000 μm, in this embodiment around 800 μm. The lenses 103-A, 103-B are arranged hexagonally on the carrier 105-A and 105-B with a focal length between 1.5 mm and 4 mm, in this embodiment 2 mm. For instance, the lenses 103-A and 103-B can be made of the same material like the carrier 105-A or 105-B or some other material. For instance, on the carrier 105-A and 105-B with a dimension of 10 mm by 10 mm, 12 times 12 lenses 103-A, 103-B are arranged. The focal length of the lenses 103-A, 103-B for example, is greater than the thickness of the carrier 105.

Since the thickness of said carrier 105-A and 105-B is sufficient, it becomes possible to fabricate the microlens array 100-A and 100-B by means of injection molding or compression molding. The focal length of the lenses 10-A at the illumination side 107-1 can be slightly increased in order to achieve the best possible illumination of the slide structures (image information) in the slide plane 111 and of the respective lenses 103-B at the projection side 107-B. The carriers 105-A and 105-B and their respective lenses 103-A and 105-B of one microlens array 100A and 100-B each can be fabricated from the same material as single piece.

In this embodiment different focal lengths are used for the lenses 103-A and 103-B at the illumination side and projection side 107-A and 107-B, so that the focal plane of the lenses 103-A at the illumination side 107-A lies exactly inside the lenses 103-B of the projection side 107-B. This results in an optimal acceptance angle of the residual divergence of the collimation. The focal length of the lenses 103-B at the projection side 107-B is selected such, that the focal plane lies inside the slide plane 111. This results in a sharp projection with the same advantages like high depth of focus for projections on a slanted plane.

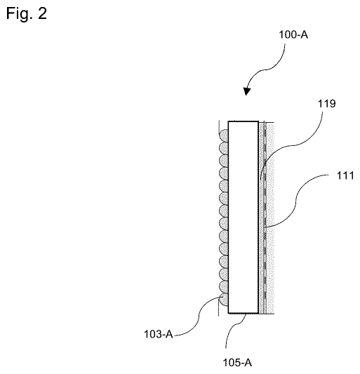

FIG. 2 shows a schematic cross-sectional view of the microlens array 100-A. The layer of the carrier 105-A has a thickness of 520 μm. The thickness of the carrier 105-A makes it possible to fabricate the microlens array 100-A by injection molding.

On the opposite side, an adhesive layer 119 (Bonding design) is provided with a thickness of 40 μm. The slide plane 111 is fixed by means of said adhesive layer 119. This results in an overall distance from the vertex of the lens 103-A to the slide plane 111 of 670 μm. The microlens array 100-B at the projection side 107-B is designed according to the microlens array 100-A at the illumination side 107-A, except that the same can comprise a carrier 107-B of greater thickness.

The alternative integrated design of the microlens array 100-A allows the same to be fabricated by using a more economical and simpler fabrication process such as injection molding. When injection molded, the microlens array 100-A, the matrix-shaped arrangement 101-A of the multiple lenses 103-A and the carrier 105-A are molded from thermoplastic polymer.

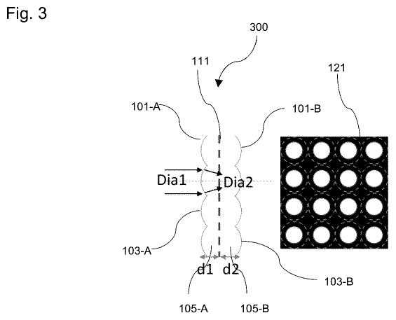

FIG. 3 shows a schematic cross-sectional view of a microlens array arrangement 300. At the slide plane 111 each partial sample is specified in the area Dia2. The area Dia2 is smaller than the area Dia1. The area Dia2 of the sample is defined by the focal length of the lens 103-A and the distance d1. The area outside the circle with area Dia2 can be covered by an absorbent or reflective material 121 in order to avoid the passage of light. The distance d1 can be smaller than the focal length of the matrix-shaped arrangement 101-A.

The carrier 105-A and 105-B can comprise multiple layers of different materials. Specific material combinations can be technically advantageous for the fabrication because of their specific material properties and requirements, such as a carrier for a chromium layer.

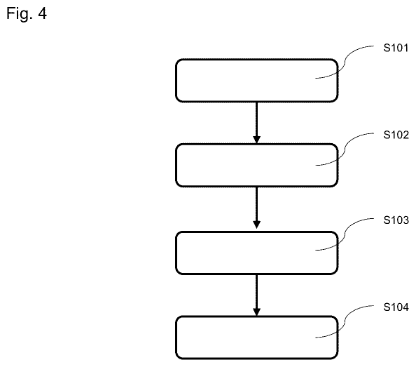

FIG. 4 shows a block diagram of a method for fabricating a microlens array arrangement 300. In step S101 a first microlens array 100-A comprising a matrix-shaped arrangement 101-A with multiple lenses 103-A which are arranged on the carrier 105-A is injection molded from thermoplastic polymer. The microlens array 101-A can also be fabricated from the carrier 105-A by means of embossing. In this case the lenses 103-A are produced on the surface of the carrier 105-A by means of a die.

In step S102, a second microlens array 100-B comprising a matrix-shaped arrangement 101-B with multiple lenses 103-B, which are arranged on the carrier 105-B, is injection molded. The second microlens array 100-B too can be fabricated by means of embossing.

In step S103, the slide plane 111 is arranged between the first microlens array 100-A and the second microlens array 100-B, in which the image information is present by means of specially designed apertures. In step S104 the first microlens array 100-A is joined with the second microlens array 100-B, while the slide plane 111 is arranged in between. Thus, this simple manner allows to produce a microlens array arrangement 300 which can be inserted into the image projector 200. In addition, said manufacturing methods allow the use of a wide selection of materials for the lenses 103-A and 103-B and the carrier 105-A and 105-B. This has optical advantages and is also advantageous in regard to manufacturing costs.

The technical advantage of the invention is the economical manufacturing method as compared to the expensive polymer on glass technology. This allows further to make use of a wider selection of materials, in particular for the carrier 105-A and 105-B. Instead of expensive polished glass wafers, basically all optical injection molding materials can be used.

Because of the dimensions, the microlens array arrangement 300 is suited in particular for the automotive sector, for instance as light for a light carpet, for symbolic projections in hotels, safety projections in airplanes, effect lighting, guidance projections or as projections for danger zones in buildings.

All process steps can be implemented by using devices that are suitable for executing the respective process step. All functions that are executed by the features of the subject-matter of the invention can constitute a process step.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A microlens array for an image projector, comprising:
a carrier; and
a matrix-shaped arrangement comprising a plurality of lenses which are arranged on the carrier.

2. The microlens array according to claim 1, wherein the carrier and the lenses are made of the same material.

3. The microlens array according to claim 2, wherein the carrier has a thickness between 400 μm and 1200 μm.

4. The microlens array according to claim 2, wherein the carrier has a thickness between 500 μm and 700 μm.

5. The microlens array according to claim 1, wherein the matrix-shapes arrangement comprising a plurality of lenses and the carrier are designed as single piece.

6. The microlens array according to claim 1, wherein the microlens array is made of a thermoplastic polymer.

7. The microlens array according to claim 6, wherein the thermoplastic polymer includes polymethyl methacrylate (PMMA), Cyclic Olefin Polymer (COP), polycarbonate (PC) or optical silicone.

8. A microlens array arrangement comprising:
a first microlens array at an illumination side; and
a second microlens array at a projection side,
wherein each of the first and second microlens arrays has a structure of the microlens array according to claim 1.

9. The microlens array arrangement according to claim 8, wherein the first microlens array include lenses having a larger focal length than lenses of the second microlens array.

10. The microlens array arrangement according to claim 8, wherein the first microlens array includes a carrier having a thickness in a range of 400 μm to 1200 μm, and the second microlens array includes a carrier having a thickness in a range of 2 mm to 5 mm.

11. The microlens array arrangement according to claim 8, wherein lenses of the first microlens array at the illumination side are characterized by a focal length within the material which is equal to a sum of a thickness of a carrier of the first microlens array and the thickness of a carrier of the second microlens array.

12. The microlens array arrangement according to claim 8, further comprising a slide plane arranged between the first microlens array and the second microlens array.

13. An image projector comprising the microlens array arrangement according to claim 8.

14. A method for fabricating the microlens array according to claim 1, the method comprising injection molding or embossing the microlens array.
